(19) United States
(12) Patent Application Publication
(10) Pub. No.: US 2010/0146354 A1
(43) Pub. Date: Jun. 10, 2010

(54) METHOD AND APPARATUS FOR H-ARQ IN A WIRELESS COMMUNICATION SYSTEM

(75) Inventors: Xiaobo Zhang, Shanghai (CN); Ni Ma, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., Eindhoven (NL)

(21) Appl. No.: 11/993,245

(22) PCT Filed: Jun. 23, 2006
(86) PCT No.: PCT/IB06/52038

§ 371 Date: Dec. 20, 2007

(30) Foreign Application Priority Data
Jun. 27, 2005 (CN) 200510079962.1

(51) Int. Cl. H04L 1/18; G06F 11/14; G06F 15/173

(52) U.S. Cl. 714/749; 709/224; 714/E11.113

(57) ABSTRACT

The present invention discloses an H-ARQ scheme: In the case of wireless channel is in good condition, user equipment will send NACK signals and other control information only when it has received an incorrect data packet, otherwise the user equipment will not send ACK signals; in the case of wireless channel is in bad condition, existing H-ARQ schemes will be adopted.

### FIELD OF THE INVENTION

The present invention relates to wireless communication field, more particularly relates to a technology that achieves Hybrid Automatic Repeat Request (H-ARQ) in wireless communication system.

### BACKGROUND OF THE INVENTION

HSDPA (High Speed Downlink Packet Access) is an important technology to realize high-speed data rate transmission in downlink of 3G system in data transmission services. H-ARQ (Hybrid ARQ) is one of the key technologies of HSDPA and is the combination of ARQ (automatic repeat request) and FEC (forward error correction).

A brief description of ARQ is given as below:

Data services come of wire network communication and ARQ is initially used for wire data communication. If data transmission failed, the receiver will request data retransmission, this is called ARQ. FIG. 1 shows the ARQ communication process in uplink transmission.

A brief description of the classification of traditional High Speed Automatic Repeat Request (H-ARQ) is given as below:

In wireless circumstance, grouping data is needed because of the deteriorated channel. The grouping data should be protected by FEC, but FEC overuse can depress the transfer efficiency. So, H-ARQ (hybrid of ARQ and FEC) is provided to solve that problem.

H-ARQ is an implicit link adaptation technique and can be divided into 3 types according to how to combine receiving data at terminal receiver:

1) HARQ-type I: The ARQ method used in current 3GPP specifications is referred to as HARQ type I. In this basic HARQ type I, the CRC (cyclic redundancy check) is added and the data is encoded with FEC code. In the receiver, the FEC code is decoded and the quality of the packet is checked (CRC check). If there are errors in the packet, a retransmission of the packet (RLC-PDU) is requested. The erroneous packet is discarded and retransmissions use the same coding as the first transmission. Compared with other two types of HARQ, this type is simplest. However, every retransmitting data has the same low probability to be received correctly because of the same coding mode.

2) HARQ-type II: The type II HARQ is a so-called Incremental Redundancy ARQ scheme. This means that the wrong RLC-PDU is not discarded but is combined with some incremental redundancy information provided by the transmitter for subsequent decoding. For type II HARQ, the retransmissions are typically not identical with the original transmission. The retransmitted part carries additional redundancy information for error correction purposes. This additional redundancy is combined with the previously received packet and the resulting code word with a higher coding gain is decoded. In hybrid ARQ type II, the retransmitted amount of redundancy is different for each retransmission, and retransmissions can in general only be decoded after combination with previous transmissions.

FIG. 2 shows an example of H-ARQ-II information code in the prior art:

Wherein codeword C0 is error-detecting code (K, L) and codeword C1 is error-correcting code (2L, L). Node B transmits C0 first, and UE detect the code according to parity bit. UE will send ACK (Acknowledgement) if no error is found and send NACK(Not-acknowledgement) if errors exist. When receive NACK, Node B will transfer P (I) again. UE combines C0 with P (I) to get C1 and executes decoding and detecting again.

3) H-ARQ-III: Like type II H-ARQ, type III H-ARQ also belongs to the Incremental redundancy ARQ schemes. This means that retransmissions concerning one RLC-PDU will not be discarded but kept at the receiver for combination with additional information before decoding. The difference is that in type III H-ARQ each retransmission is self-decodable. Thus, the data can be recovered from the retransmitted packet without combining if it is transmitted with a low enough Bit Error Rate.

H-ARQ can significantly increase user throughput over independent ARQ and FEC. For H-ARQ, there are three types of transfer schemes to control transmitting ACK/NACK: Stop-and-wait (SAW), Selective-repeat (SR), SAW-Hybrid.

Stop and Wait (SAW)

Stop-and-wait (SAW) is one of the simplest forms of ARQ requiring very little overhead. FIG. 3 shows the H-ARQ process using SAW schemes in the prior art. As shown in FIG. 3, in stop-and-wait, the transmitter operates on the current block until the block has been received successfully. Protocol correctness is ensured with a simple one-bit sequence number that identifies the current or the next block. As a result, the control overhead is minimal Acknowledgement overhead is also minimal, as the indication of a successful/unsuccessful decoding (using ACK, NACK, etc) may be signalled concisely with a single bit. Furthermore, because only a single block is in transit at a time, memory requirements at the UE are also minimized. However, one major drawback exists: acknowledgements are not instantaneous and therefore after every transmission, the transmitter must wait to receive the acknowledgement prior to transmitting the next block. In the interim, the channel remains idle and system capacity goes wasted. In a slotted system, the feedback delay will waste at least half the system capacity while the transmitter is waiting for acknowledgments.

Selective Repeat (SR)

Window-based (WB) Selective Repeat (SR) is a common type of ARQ protocol employed by many systems. SR is generally very sensitive to delay and has the favorable property of repeating only those blocks that have been received in error. To accomplish this feat, the SR ARQ transmitter must employ a sequence number to identify each block it sends. FIG. 4 shows the H-ARQ identifying process with SR scheme. As shown in FIG. 4, SR scheme may fully utilize the available channel capacity by ensuring that the maximum block sequence number (MBSN) exceeds the number of blocks transmitted in one round trip feedback delay. The greater the feedback delay the larger the maximum sequence number must be.

SAW-HARQ

For HSDPA an N-channel SAW-H-ARQ implementation has been proposed, which is an ARQ method with the minimal complexity of stop-and-wait and the throughput efficiency of SR. To make clear the SAW-H-ARQ process, below will show a dual channel SAW-Hybrid ARQ implementation, which is an example of N-channel SAW-H-ARQ (N=2).

The downlink (DL) data timeslot is divided into even and odd timeslots to identify the independent instances of the Hybrid ARQ protocol. By combining even with odd time slots in data transmitting, two independent downlink logic channels have been created. The uplink(UL) feedback timeslot is also divided into even and odd timeslots to transfer the ACK/NACK messages, which compose the even and odd UL feedback channels. Each channel pair (even up-and-down channel, odd up-and-down channel) performs a conventional stop-and-wait ARQ algorithm in its respective time slot by transmitting the data blocks on the data channel. As a result, when one channel is waiting for the ACK/NACK message, the other channel can transfer data at the next downlink timeslot, so the channel transfer efficiency is improved.

Physical Layer Aspects of H-ARQ

HSDPA technology increases a transport channel HS-DSCH (high speed downlink shared channel) to improve DL transmission and a physical channel HS-SICH (shared information channel) is used to transfer uplink feedback messages associated with HS-DSCH. The current specifications mandate setting up DPCH (dedicated physical channel) both in the UL and in the DL whenever a user is configured to use HS-DSCH. In case such users are not doing any conversational types of services, the corresponding DPCH will carry pilots and TPC bits (controlling part). The users must establish DPCH connection before they are assigned HS-DSCH services which wastes channel resources if the users do not perform any conversational types of services.

In current specification, every time a data packet is received, HS-SICH is used to transmit H-ARQ feedback information (ACK (Acknowledgement)/ NACK (Not-acknowledgement)) and some control information. DPCHs (Dedicated Physical Channel, comprising downlink and uplink) are also assigned to the UEs (user equipment) that occupy the HS-DSCH. In case such UEs are not performing any conversational types of services, the corresponding DPCH will carry pilots and TPC (Transmit Power Control) bits and possibly the associated RRC (Radio Resource Control) signalling. Such types of users are named HSDPA data-only users.

For those data-only users under good transmission conditions, transmission circumstance is stable so they don't need frequently change transmission states by sending TPC (transmit power control) and CQI (channel quality indicator). However, in HS-SICH, TPC and CQI are transferred with ACK/NACK message, which should be sent frequently (every ACK/NACK is associated with a received data packet). In fact, for UEs under good transmission conditions, most H-ARQ-related signals are “ACK” but not “NAK” because the probability of correct transmission is very high under good transmission conditions. It is obvious that the use rate of radio resources in H-ARQ of prior art is poor. Thus, in order to save the radio resources and improve the channel capacity, a novel H-ARQ scheme shall be provided to increase the use rate of radio resources.

### OBJECT AND SUMMARY OF THE INVENTION

To this end, a novel H-ARQ implementation mechanism is proposed: UEs send NACK signal and other control information if needed and there is no need to send ACK signals when receive data packets correctly.

With current specification, for those UEs in “good” state (good transmission conditions), they have to frequently transmit control information though the channel is quite stable, which greatly waste the radio resources. The present invention provides a new H-ARQ scheme, which makes UEs only send information (NAK/CQI/TPC) when at least one of the following three events occur(s):
1) Find errors in the received data packets;
2) Channel quality has changed so much that it's necessary to notify UTRAN (UMTS Radio Access Network) by sending CQI;
3) DL transmission power doesn't meet the requirements of the current transmission.

Fortunately, under stable transmission conditions, none of the three situations occurs frequently, so UEs can remarkably reduce the probability of occupying HS-SICH with the H-ARQ scheme in the present invention.

According to the first aspect of the present invention, a method for implementing automatic repeat request (ARQ) for data transmission in a communication apparatus is provided, which comprises the following steps:

(a) monitoring a channel quality value between the communication apparatus and a network device;

(b) comparing the channel quality value with a predefined threshold to obtain a comparison result; and

(c) executing the following steps if the channel quality value is not worse than the predefined threshold:
(c1) monitoring if the current transmission condition is normal; and
(c2) sending a request message to the network device for adjusting the transmission condition if the transmission condition is abnormal.

According to the second aspect of the present invention, a communication apparatus for performing ARQ is provided, which comprises:

a transmitting means for transmitting uplink data to a network device;

a monitoring means for monitoring the channel quality value between the network device;

a comparing means for comparing the channel quality value with a predefined threshold to obtain a comparison result;

a controlling means for controlling the monitoring means to monitor whether the transmission condition is normal when the channel quality value is not worse than the predefined threshold, and controlling the transmitting means to send a request message to the network means if the transmission condition is abnormal.

According to the third aspect of the present invention, a method for implementing ARQ for data transmission in a network device is provided, which comprises the following steps:

(a) receiving the state switch inform message from a communication apparatus; and

(b) adjusting the current transmission condition if the state switch inform message indicates that the channel quality value between the communication means and the network means is not worse than a predefined threshold and there is a request message received which is from the communication apparatus.

According to the fourth aspect of the present invention, a network device for performing ARQ is provided, which comprises:

a receiving means for receiving state switch inform message from a communication apparatus;

a transmitting means for transmitting downlink data to the communication apparatus;

a controlling means for adjusting the transmission condition of the transmitting means if the state switch inform message indicates that the channel quality value between the communication apparatus and the network device is not worse than a predefined threshold and there is a request message received which is from the communication device.

As compared with the prior art, in the present invention, if the radio channel quality is good, UE sends corresponding request message to network means only when the transmission condition is abnormal (such as incorrect data packets are found, channel quality changes too much or transmission power is unsuitable), that increase the use rate of radio resources greatly.

For understanding the other objects and effects of the present invention more clearly and completely, a detailed description will be made in combination with the accompanying drawings hereinafter.

### BRIEF DESCRIPTION OF THE DRAWINGS

The preferred embodiments of the present invention will be described with reference of the companying drawings as follows:

FIG. 1 shows the communicating process of ARQ in the prior art;

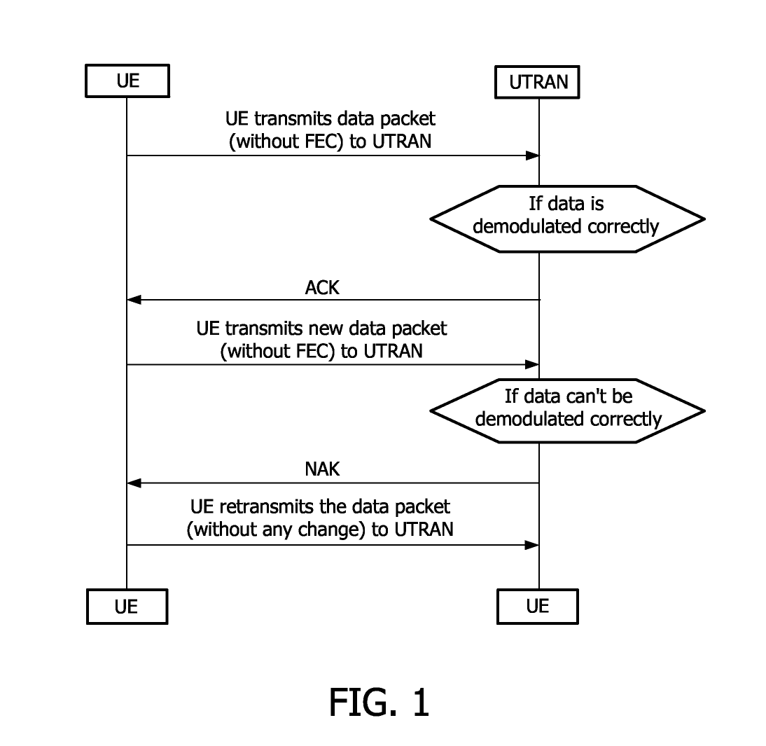

FIG. 2 shows an example of message code in H-ARQ-II in the prior art;

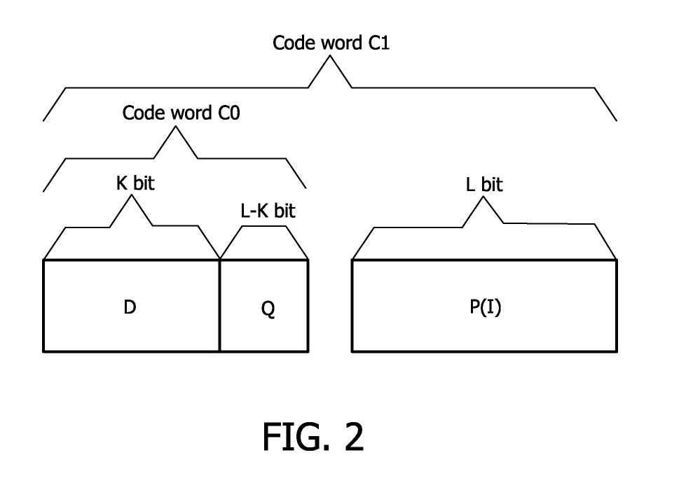

FIG. 3 shows the H-ARQ process using SAW scheme;

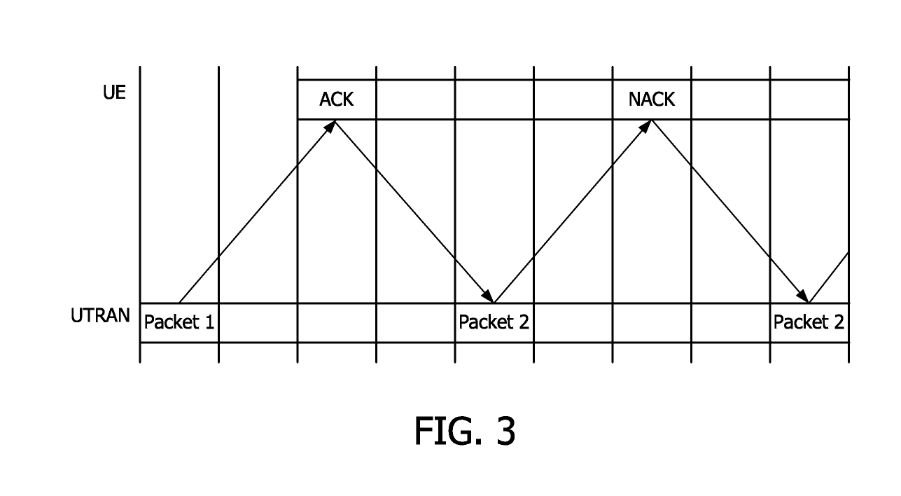

FIG. 4 shows the H-ARQ confirm process using SR scheme;

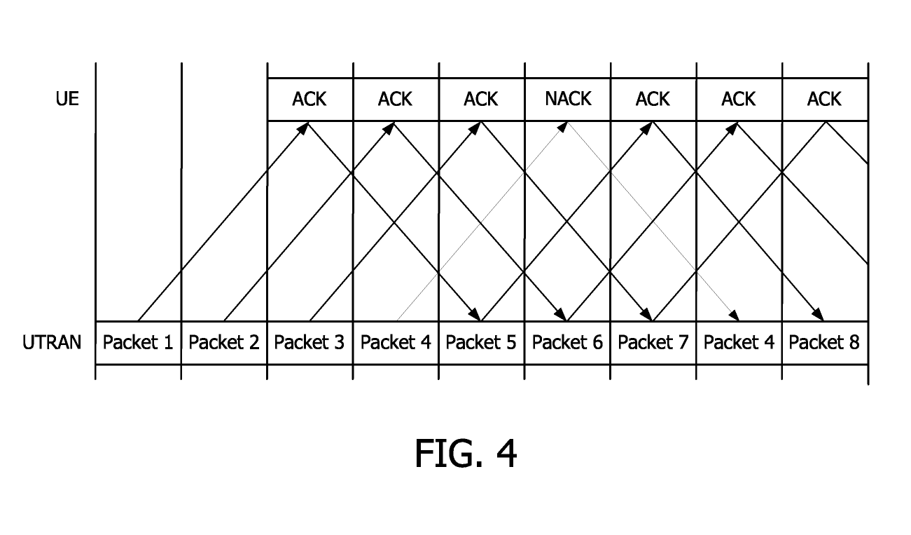

FIG. 5 shows a UE for performing ARQ in wireless communication system according to a preferred embodiment of the present invention;

FIG. 6 shows the flow chart of the method for performing ARQ in UE in wireless communication system according to a preferred embodiment of the present invention;

FIG. 7 shows a network means for performing data transmission ARQ in wireless communication system;

FIG. 8 shows the flow chart of the method for performing data transmission ARQ in network means in wireless communication system according to a preferred embodiment of the present invention;

FIGS. 9 and 10 show the process of User Equipment informing the network means (UTRAN) about the changes of wireless channel quality state to realize state switch in a preferred embodiment;

FIG. 11 shows the NAK-only confirmation mechanism according to a preferred embodiment of the present invention;

FIG. 12 shows the communicating process between UE and UTRAN of H-ARQ schemes according to a preferred embodiment of the present invention.

In the drawings same reference signs indicate same or similar feature.

### DETAILED DESCRIPTION OF THE INVENTION

Hereinafter, the present invention will be described with reference with the companying drawings in detail.

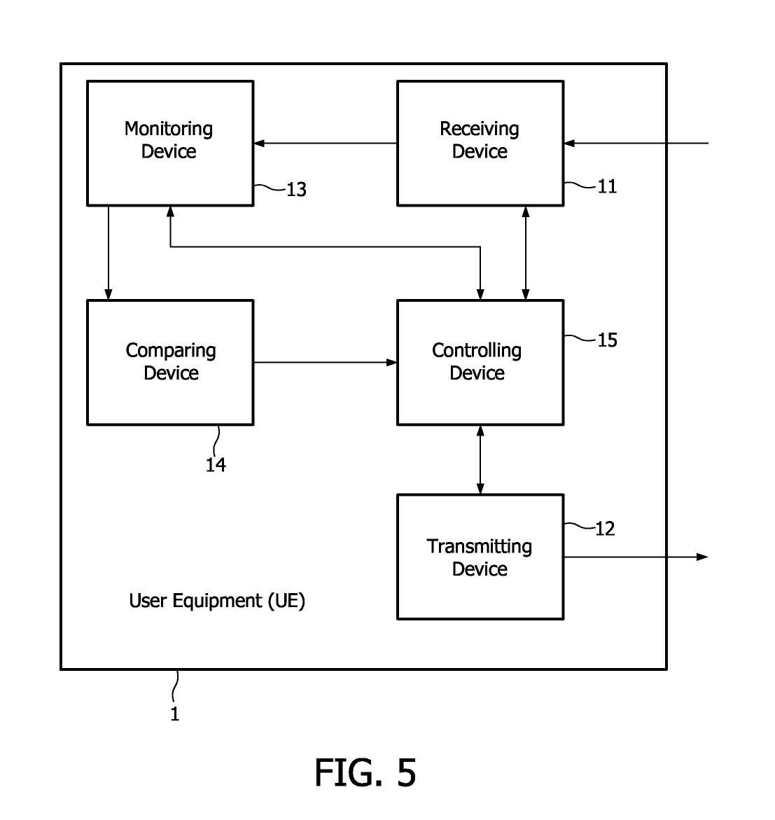

FIG. 5 shows a User Equipment (UE) 1 for performing ARQ in wireless communication system according to a preferred embodiment of the present invention, the UE1 comprises a receiving means 11, a transmitting means 12, a monitoring means 13, a comparing means 14 and a controlling means 15.

Wherein, the receiving means 11 is used for receiving the downlink data from a network device. The transmitting means 12 is used for transmitting uplink data to the network device. The monitoring means 13 is used for monitoring the current wireless channel quality T (comprising SIR or E_{b}/N₀ or some other standards). As mentioned above, during the whole telecommunication connection procedure of the present invention, the monitoring means 13 must monitor the wireless channel quality T continuously.

The comparing means 14 is used for comparing the measured wireless channel quality T with a predefined threshold (T₀). If the measured wireless channel quality T is better than T₀ or equal to T₀, then it is deemed that the UE is in “good” state, while if the measured wireless channel quality T is worse than T₀, then it is deemed that the UE is in “bad” state. The two kinds of states are shown in table 1 as below:

### Table 1: Scheme for Determining UE States

TABLE 1
Scheme for determining UE states

| Wireless Channel Quality | UE states |
|---|---|
| Measured wireless channel quality T is better | Good |
| than or equal to T₀ | |
| Measured wireless channel quality T is worse | Bad |
| than T₀ | |

The controlling means 15 will determine the H-ARQ mode to be adapted according to the comparison result, that is, the “good” or “bad” state that UE is in. If the UE is in “good” state, UE will select the H-ARQ scheme proposed by the present invention. In that case, only when the transmission condition is abnormal, UE sends request message to network means. If the UE is in “bad” state, UE will select traditional H-ARQ scheme to communicate with the network device.

Particularly, if the measured wireless channel quality T is better than or equal to the predefined threshold T₀, the controlling means 15 will perform following functions:

controlling the monitoring means 13 to monitor if the current transmission condition is normal, wherein the condition may comprise: the correctness of the received data packet, the value of the downlink transmission power and the channel quality etc.

controlling the transmitting means 12 to send a request message to the network means when the transmission condition is abnormal. The request message may contain: retransmission request message for the retransmission of incorrect data packets, transmission power control message for adjusting abnormal downlink transmission power and channel quality indication message for reflecting the channel quality.

If the measured wireless channel quality T is worse than the predefined threshold T₀, the controlling means 15 is used for controlling UE to use one of the three existing kinds of H-ARQ methods to communicate with the network device.

As mentioned above, in order to let network device know the H-RAQ scheme that UE will adopt, UE needs to inform network device of the comparison result from the comparing means 13, or may send a state switch request message to network device only when the result changes (namely wireless channel quality state is changing up-and-down around the predefined threshold).

The mobile communication system may be a High Speed Downlink Packet Access (HSDPA)-based CDMA system, preferably, can be UMTS Radio Access Network (UTRAN); and the network device can be a wireless resources controller.

In one preferred embodiment, the controlling means 15 controls other means to send the request message or notification message to network device by performing following functions:

controlling the transmitting means 12 to send a channel distribution request message through Physical Uplink Shared Channel (PUSCH) to the network device to request distributing the High Speed Shared Information Channel (HS-SICH).

controlling the receiving means 11 to receive channel distribution message from the network device on High Speed Shared Control Channel (HS-SCCH). The message is used for distributing the HS-SICH.

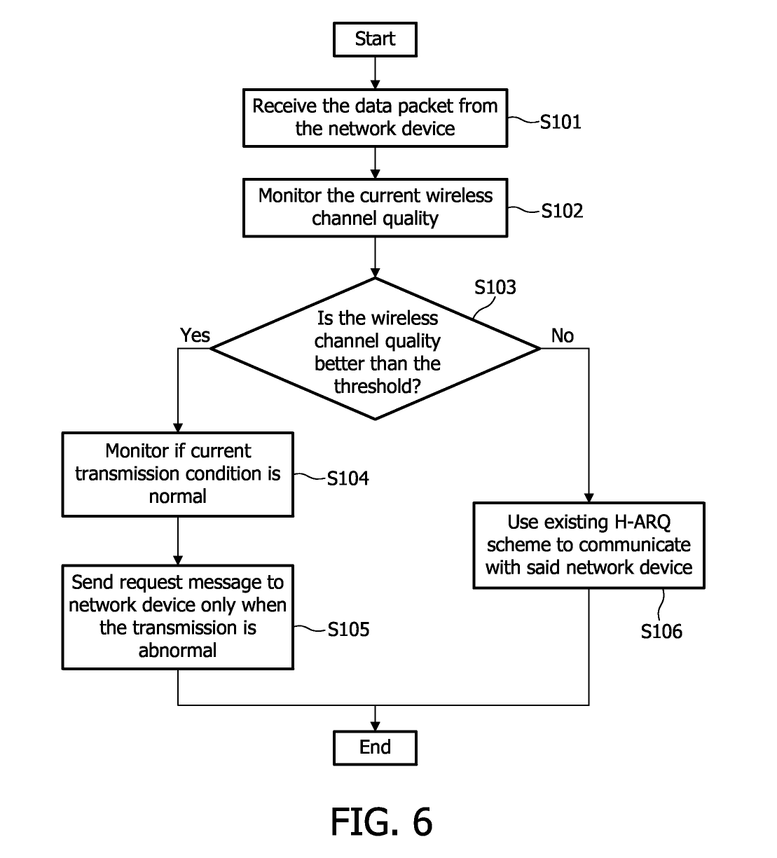

FIG. 6 shows a method for performing ARQ in UE of a mobile communication system according to a preferred embodiment of the present invention.

Particularly, in step S101, receiving the data packet from network device;

Then, in step S102, monitoring the current wireless channel quality T. During the whole telecommunication connecting procedure of the present invention, the monitoring means must be monitoring the wireless channel quality continuously;

In step S103, comparing the measured wireless channel quality with a predefined threshold. If the measured wireless channel quality T is better than or equal to T₀, then it is deemed that UE is in “good” state, proceed to step 5104; if the measured wireless channel quality measured is worse than T₀, then it is deemed that UE is in “bad” state, proceed to step S106. The two states are shown in the above table 1.

In step S104, monitoring if the transmission condition is normal, the transmission condition comprises: the correctness or the data packet received, the value of the downlink transmission power and the channel quality etc.;

In step S105, sending a request message to the network device only when the transmission condition is abnormal,. The request message comprise: retransmission request message for requesting the retransmission of incorrect data packet, transmission power control message for requesting adjusting abnormal downlink transmission power and channel quality indicate message for reflecting the channel quality;

In step S106, use one of the three traditional H-ARQ methods to communicate with the network means.

Further more, to let network device know the H-RAQ scheme that UE will adopt, the method further comprises a step of:

informing network means of the comparison result got in S103, or may send a state switch request message to network device only when the comparison result changes (namely wireless channel quality state is changing up-and-down around the predefined threshold).

The mobile communication system may be an HSDPA-based CDMA system and, preferably, can be a UMTS Radio Access Network (UTRAN); and the network device can be a wireless resources controller.

In a preferred embodiment, request message or inform message can be sent to the network device by means of the following steps of:

sending a channel distribution request message through PUSCH to the network device to request distributing the HS-SICH;

receiving channel distribution message from the network device on HS-SCCH for distributing the HS-SCCH.

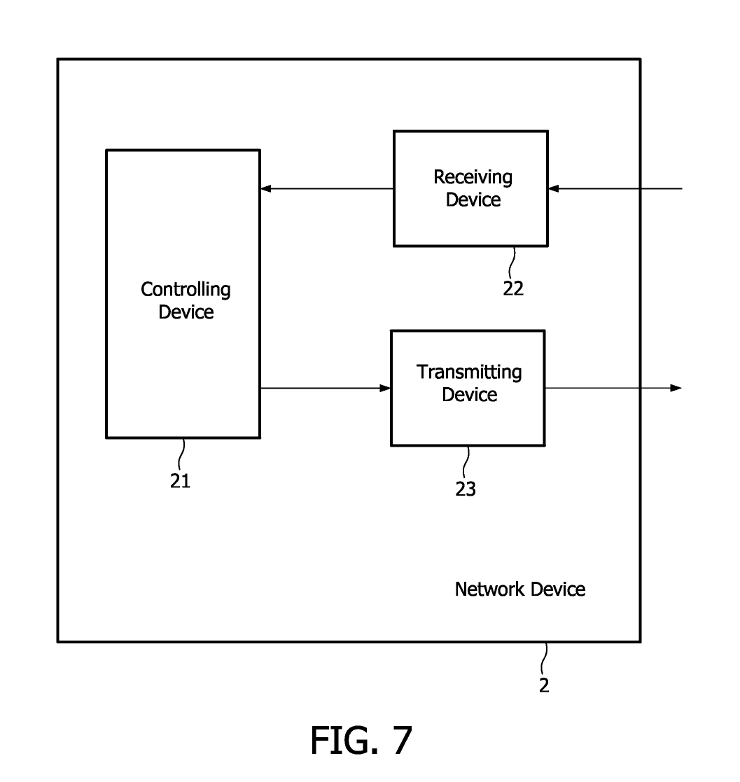

FIG. 7 shows a network means 2 for performing ARQ in data transmission in mobile communication system, comprising a receiving means 22, a transmitting means 23 and a controlling means 21.

The receiving means 22 is used for receiving the state switch inform message from UE1. The state switch inform message is used for indicating the changes of UE's state (namely wireless channel quality state is changing up-and-down around the predefined threshold).

The transmitting means 23 is used for transmitting downlink data to the UE.

The controlling means 21 is for performing corresponding operations only when receiving a request message from a UE, in case that the state switch inform message indicates that current wireless channel quality is better than the predefined threshold.

The request message comprises: retransmission request message for requesting the retransmission of incorrect data packet, transmission power control message for requesting adjusting abnormal downlink transmission power and channel quality indicate message for reflecting the channel quality.

The corresponding operations comprise: resending the data packet after receiving retransmission request message; adjusting the downlink transmission power after receiving transmission power control message; selecting an appropriate modulating coding method according to the channel quality indicate message.

Controlling means 21 is also used for choosing one of the three existing kinds of H-ARQ methods to communicate with the UE when the state switch inform message indicates that the wireless channel quality is worse than the predefined threshold.

Preferably the controlling means 22 is also for controlling the receiving means to receive the request message or inform message from the UE on HS-SICH.

More preferred, the controlling means 21 further performs the following functions:
controlling the receiving means 22 to receive a channel distribution request message for distributing the HS-SICH through PUSCH from the UE;
controlling the transmitting means 23 to send a channel distribution message for distributing the HS-SICH to the UE through HS-SCCH.

The mobile communication system can be an HSDPA-based CDMA system, preferably, can be UTRAN; and the network device can be a wireless resources controller.

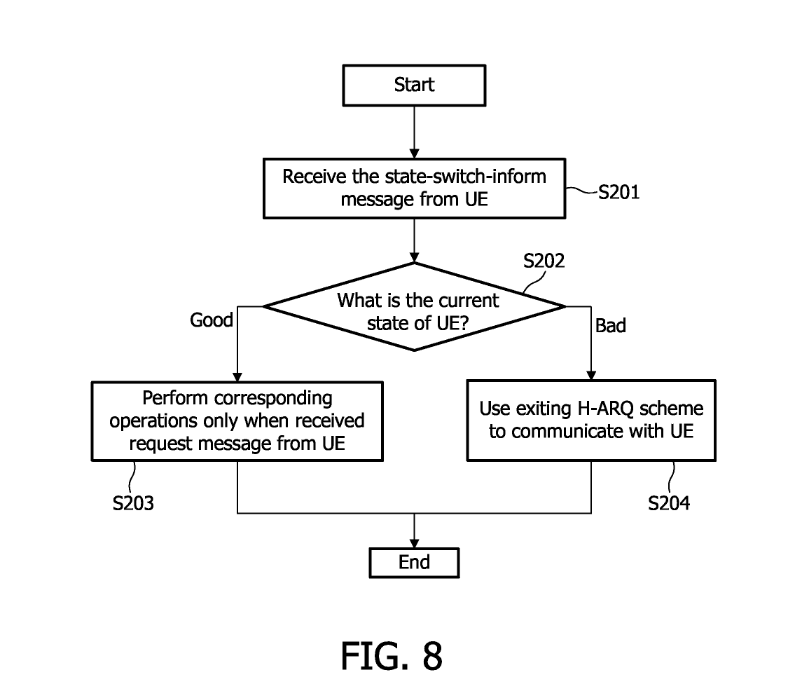

FIG. 8 shows the method for performing data transmission ARQ in network device of a wireless communication system according to a preferred embodiment of the present invention.

As shown in the figure, in step S201, receiving the state switch inform message from the UE; the state switch inform message is used for indicating the changes of UE's state (namely wireless channel quality state is changing up-and-down around the predefined threshold).

When the state switch inform message indicates that UE is in “good” state, namely wireless channel quality is better than or equal to the predefined threshold, proceed to step S202; when the state switch inform message indicates that current wireless channel quality is worse than the predefined threshold, proceed to step S203;

In step S202, performing corresponding operations only when receive a request message from UE1;

The request message comprises: retransmission request message for requesting the retransmission of incorrect data packet, transmission power control message for requesting adjusting abnormal downlink transmission power and channel quality indicate message to indicate the channel quality.

The corresponding operations comprising: resending the data packet after receiving retransmission request message; adjusting the downlink transmission power after receiving the transmission power control message; selecting proper modulating code method in accordance with the channel quality indicate message.

In step S203, adopting one of the three existing kinds of H-ARQ methods to communicate with the UE1.

The mobile communication system may be an HSDPA-based CDMA system, preferably, can be a UMTS Radio Access Network (UTRAN); and the network device can be a wireless resources controller.

In a preferred embodiment, receiving request or inform message is realized by means of the following steps:

receiving the request or inform message from the UE on HS-SICH.

More preferably, receiving request message or inform message further comprises the following steps:

receiving the channel distribution request message for distributing the HS-SICH from the UE on PUSCH;

transmitting a channel distribution message for distributing the HS-SICH to the UE through HS-SICH.

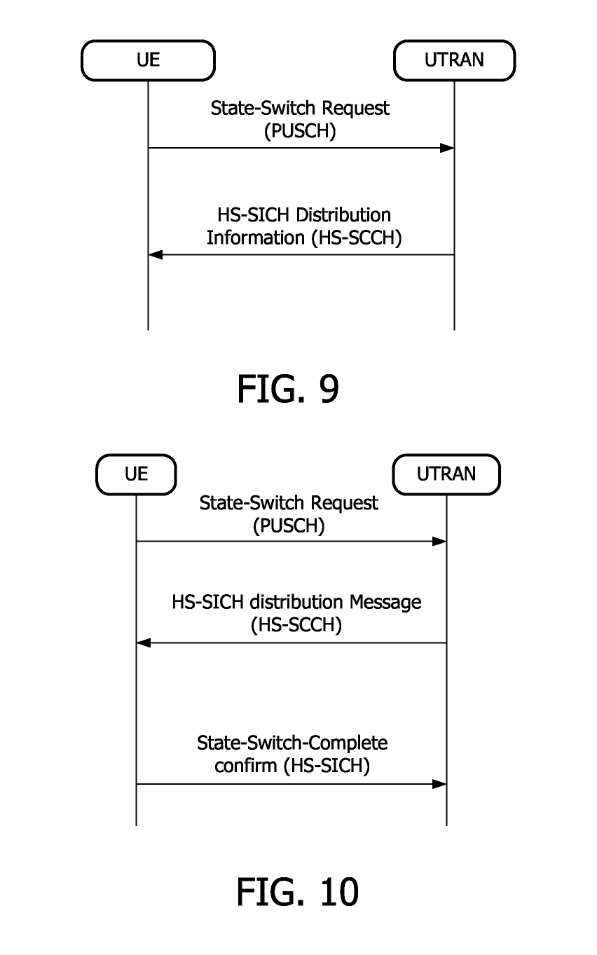

FIGS. 9 and 10 show the process that UE informs the network device (UTRAN) about the changes of wireless channel quality state so as to realize state switch in a preferred embodiment. Hereinafter, the process of state switch will be described with reference with FIGS. 8 and 9 specifically.

From “Good” to “Bad”

UE is always monitoring the wireless channel quality (namely the transmission circumstance) by receiving and processing BCH, PCH, DSCH data and midamble information. As shown in FIG. 9, When UE affirms that the wireless channel quality is worse than the predefined threshold, it should send a request for distributing HS-SICH to the UTRAN through PUSCH, then US monitors HS-SCCH. Then, UTRAN will distribute HS-SICH to the UE by sending control information on HS-SCCH.

From “Bad” to “Good”

As shown in FIG. 10, in case that UE find the measured wireless channel quality has become to be better than he predefined threshold, it will inform UTRAN of this result to change its state and release HS-SICH resources. First, UE sends a state switch request message for state switch to UTRAN on HS-SICH, and then UTRAN sends confirm message and HS-SICH released message to UE on HS-SCCH. When UE receives the confirm message and HS-SICH released message, it should send state-switch-complete confirm message to UTRAN via PUSCH and get into “good” state.

As for HS-SICH distribution schemes for UEs in “good” state:

Though not frequently, uplink messages (NACK, CQI, TPC) should be sent now and then.

For these UEs in good transmission condition, two schemes can be applied to distribute HS-SICH.

i. Requesting for HS-SICH Before Transmission
When one or more of the above three situations occur and UE needs to send NAK/CQI/TPC messages, it will request for distributing HS-SICH through PUSCH. UE can transfer uplink information after UTRAN distributes HS-SICH resource for it. When UE completes sending messages, it should inform the UTRAN and release the HS-SICH resources through the PUSCH. This method occupy the minimum channel resources, however, it need a long connection time when transferring a message, which makes the receiver have to increase the buffer length.

ii. Sharing HS-SICH Scheme
In this sharing HS-SICH scheme, more UEs share less HS-SICHs compared with traditional H-ARQ scheme. When UEs want to send messages, they occupy the HS-SICH by competing. Because UEs in good transmission conditions seldom need to transfer uplink signals, collision will hardly occur. This scheme can make UE send uplink message in time with less HS-SICHs distributed than traditional schemes.

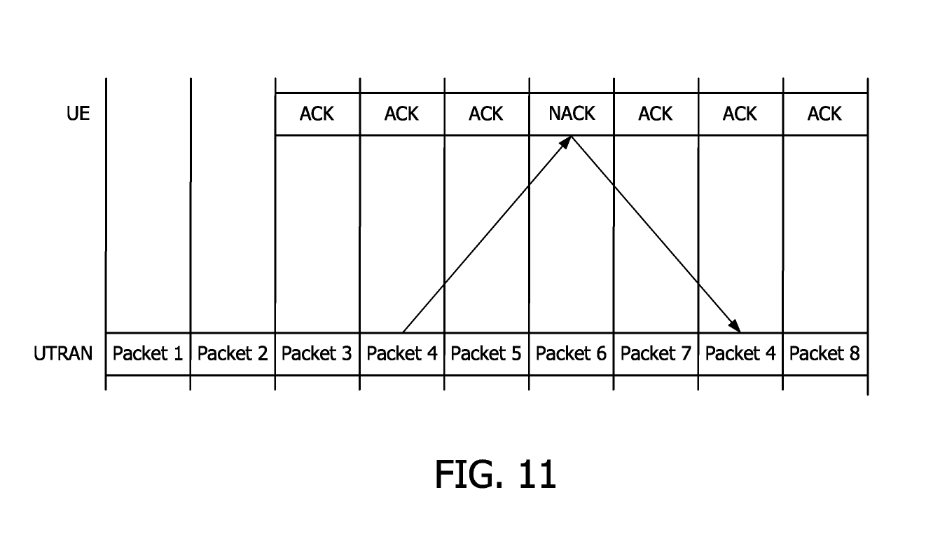

It is assumed that no TPC (Transmit Power Control) or CQI (Channel Quality Indicator) signals need to be sent, NACK-only confirm scheme is shown in FIG. 11. When incorrect data packet found, UEs only send NACK(combined with data packet serial number) to UTRAN, then UTRAN will resend corresponding data packet. With the NACK-only scheme, these UEs can share less HS-SICHs.

As described above, in the prior art, UE should send ACK each time when it receives a data packet correctly, and send NACK each time when it receives a data packet incorrectly. However, with the technical schemes of the present invention, the UEs need to send NACK signal only when received an incorrect data packet so that less HS-SICH resources will be occupied.

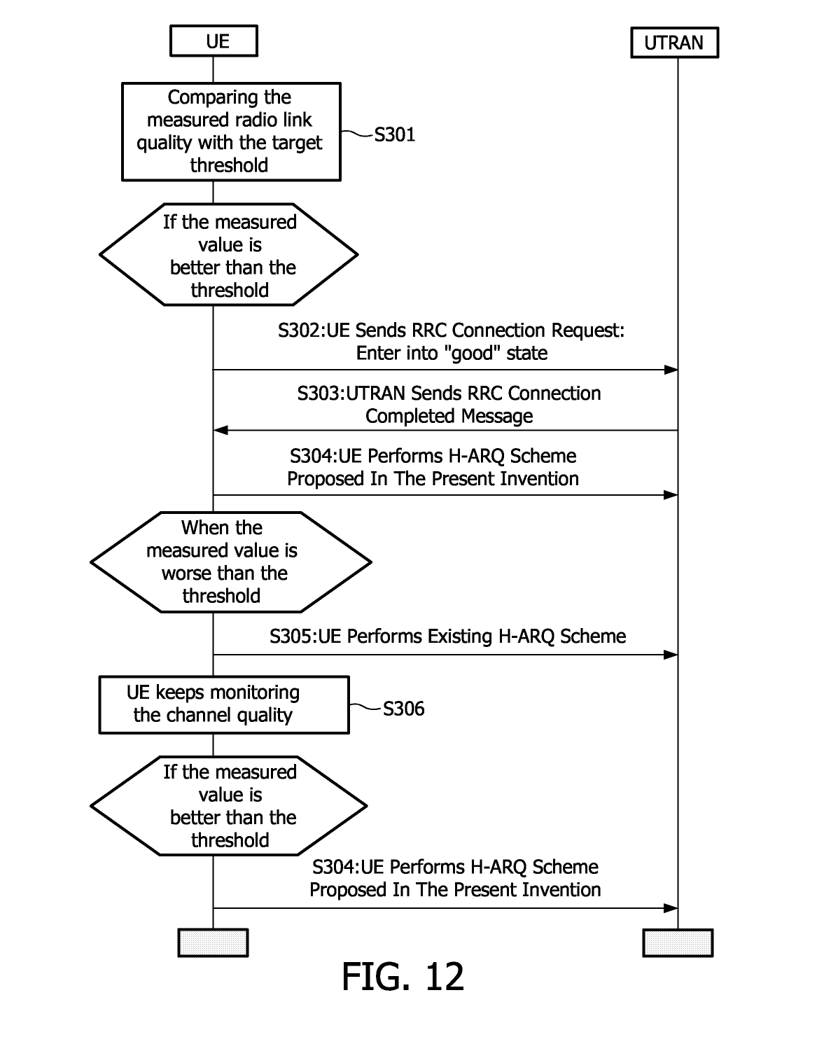

FIG. 12 shows the communicating process between UE and UTRAN with H-ARQ schemes according to a preferred embodiment of the present invention.

As shown in FIG. 12, firstly, UE compares the measured wireless channel quality with the aim threshold (step S301). If the measured value is better than the threshold, UE sends a RRC connection request to UTRAN: enters into “good” state (in step S302), then UTRAN sends message for identifying RRC connection accomplished to UE (in step S303). UE then performs HSDPA communication with UTRAN using the H-ARQ scheme proposed by the present invention (in step S304). If the value measured is worse than the threshold, UE enters in “bad” state and performs the existing H-ARQ schemes (in step S305). Then UE keeps monitoring the channel quality (step S306). If it finds that the measured value is better than the threshold, UE will switch from “bad” to “good” and perform the H-ARQ scheme proposed by the present invention and proceed to step 5304 again.

Although the present invention has been described in detail, it should be understood that various changes, substitutions and alterations can be made hereto without departing from the spirit and scope of the invention as described by the appended claims.

1. A method for implementing automatic repeat request (ARQ) for data transmission in a communication apparatus, comprises the following steps:
(a) monitoring a channel quality value between said communication apparatus and a network device;
(b) comparing said channel quality value with a predefined threshold to obtain a comparison result; and
(c) executing the following steps if said channel quality value is not worse than said predefined threshold:
(c1) monitoring if the current transmission condition is normal; and
(c2) sending a request message to said network device for adjusting said transmission condition if said transmission condition is abnormal.

2. The method according to claim 1, further comprises the following step (d): adopting one of the three kinds of Hybrid automatic repeat request (H-ARQ) methods: Stop and Wait (SAW), Selective Repeat (SR) and SAW-Hybrid to communicate with said network device if said channel quality value is worse than said predefined threshold.

3. The method according to claim 1, wherein step (b) further comprises the following step:
(b1) sending the comparison result to said network device if said comparison result changes;

4. The method according to claim 1, wherein said channel quality value comprises the SNR.

5. The method according to claim 1, wherein said transmission condition comprises the correctness of the received data packet.

6. The method according to claim 5, wherein said request message comprises: requesting said network device for resending a data packet if said communication means receives the data packet incorrectly.

7. The method according to claim 1, wherein said request message in step (c2) is sent to said network device via High Speed Shared Information Channel (HS-SICH).

8. A communication apparatus for performing ARQ, comprises:
a transmitting means for transmitting uplink data to a network device;
a monitoring means for monitoring the channel quality value between said network device;
a comparing means for comparing said channel quality value with a predefined threshold to obtain a comparison result;
a controlling means for controlling said monitoring means to monitor whether the transmission condition is normal when said channel quality value is not worse than said predefined threshold, and controlling said transmitting means to send a request message to said network means if the transmission condition is abnormal.

9. The communication apparatus according to claim 8, wherein said controlling means is also used for controlling said communication device to adopt one of the three kinds of Hybrid automatic repeat request (H-ARQ) methods: Stop and Wait (SAW), Selective Repeat (SR) and SAW-HARQ to communicate with said network device if said channel quality value is worse than said predefined threshold.

10. The communication apparatus according to claim 8, wherein said transmitting means will send the comparison result to said network means if said comparison result changes.

11. The communication apparatus according to claim 8, wherein said transmission condition comprises the correctness of the data packet received.

12. The communication apparatus according to claim 11, wherein said request information comprises: requesting said network device for resending the data packet if said communication apparatus receives the data packet incorrectly.

13. A method for implementing ARQ for data transmission in network device, comprises the following steps:
(a) receiving the state switch inform message from a communication apparatus; and
(b) adjusting the current transmission condition if said state switch inform message indicates that said channel quality value between said communication means and said network means is not worse than a predefined threshold and there is a request message received which is from said communication apparatus.

14. The method according to claim 13, further comprises a step (c):
using one of the three kinds of Hybrid automatic repeat request (H-ARQ) methods: Stop and Wait (SAW), Selective Repeat (SR) and SAW-HARQ to communicate with said user equipment if said state switch inform message indicates that said channel quality is worse than said predefined threshold.

15. The method according to claim 13, wherein said request message comprises: requesting said network means for resending the data packet if said communication means receives the data packet incorrectly.

16. The method according to claim 15, wherein the operation of adjusting current transmission in step (b) comprises resending said data packet when receives said request message.

17. A network device for performing ARQ, comprises:
a receiving means for receiving state switch inform message from a communication apparatus;
a transmitting means for transmitting downlink data to said communication apparatus;
a controlling means for adjusting the transmission condition of said transmitting means if said state switch inform message indicates that said channel quality value between said communication apparatus and said network device is not worse than a predefined threshold and there is a request message received which is from said communication device.

18. The network device according to claim 17, wherein said request message comprises:
requesting said network device for resending the data packet if said communication means receives the data packet incorrectly.

19. The network device according to claim 18, wherein said controlling means will control said transmitting means to resend said data packet when said request message is received.
